(19) United States
(12) Patent Application Publication
(10) Pub. No.: US 2006/0013272 A1
(43) Pub. Date: Jan. 19, 2006

(54) Laser system with optical parametric amplifier

(75) Inventors: Daniel Kopf, Altach (AT); Maximilian Josef Lederer, Alberschwende (AT)

Correspondence Address: OLIFF & BERRIDGE, PLC, P.O. BOX 19928, ALEXANDRIA, VA, 22320, US

(73) Assignee: HIGH Q LASER PRODUCTION GMBH, Hohenems (AT)

(21) Appl. No.: 11/157,926

(22) Filed: Jun. 22, 2005

Related U.S. Application Data
(60) Provisional application No. 60/582,110, filed on Jun. 24, 2004.

(51) Int. Cl. H01S 3/13

(52) U.S. Cl. 372/30

(57) ABSTRACT

In a laser system with optical parametric amplifier (8), a laser source (1) for generating seed pulses, and a regenerative amplifier (2) for generating pump pulses, the seed pulses of laser source (1) are coupled, both into the regenerative amplifier (2) and into the optical parametric amplifier (8). Moreover, the auxiliary beam (HS) generated in the optical parametric amplifier (8) is passed through an arrangement with positive dispersion (14) so that, in view of the inverted chirp of the auxiliary beam (HS), the pulses are recompressed. A pulse stretcher can also be used as an arrangement with positive dispersion for recompression of the auxiliary beam (HS), so that a further component can be omitted.

The invention concerns a laser system with optical parametric amplifier according to the preamble of claim 1.

More and more often, laser setups used to generate short pulses for industrial and scientific applications must meet the demands of a compact and simple structure as well as of flexibility in beam production, such as the generation of special wavelengths.

In solid-state lasers, the number of wavelengths that can be generated directly by laser processes is given by the laser-active media that can be used, therefore, subsequent processes in which the wavelength of the laser light is changed are employed in order to open up other spectral ranges. Optical parametric oscillators or optical parametric amplifiers are examples for such processes.

The pulses to be amplified are stretched in time in order to avoid harmful effects of high intensities on the amplifier material. Here, a suitable approach is given with the concept of chirped-pulse amplifiers, where a chirped pulse is stretched when passing through a material with positive dispersion. The stretched pulse is coupled into an amplifier, and recompressed after amplification. A path having negative dispersion where the chirped pulse is contracted on the time axis is used for recompression. Here, examples of suitable components are prism pairs or dispersive layer structures such as Gires-Tournois interferometers.

The smaller the amplification cross sections of the amplifier medium, the more must pulses be stretched in conventional chirped-pulse amplifiers. It may become necessary then to use large diffraction gratings and optics separated by long paths in order to achieve the required pulse stretching, which leads to a disadvantageous design situation.

In an optical parametric amplifier, to the contrary, the intensity of the pump pulse is followed by parametric amplification without any delay. For a given pulse energy and pulse duration, suitable values optimizing the parametric amplification of auxiliary beam and signal beam without allowing the intensities to rise above the harm threshold can be found for the pump beam range and length of the nonlinear medium. Here, pump pulse and seed pulse must overlap in space and time in order to achieve efficient parametric amplification.

An example of an optical parametric amplifier used in combination with chirped pulses (OPCPA: optical parametric chirped pulse amplification) is described in “Evaluation of a novel front end amplification technique for Vulcan”, by J. Collier et al., CLF Annual Report 1997/98, pp. 143-146. A theoretical discussion of the conditions for OPCPA was given by Ross et al. in “An analysis and optimisation of optical parametric chirped pulse amplification”, Central Laser Facility Annual Report 2000/2001, pp. 181-183.

The configuration and optimization of OPCPA systems are described, for instance, in “High-conversion-efficiency optical parametric chirped-pulse amplification system using spatiotemporally shaped pump pulses”, LLE Review, Volume 93, pp. 33-37, and in “Design of a highly stable, high-conversion-efficiency, optical parametric chirped-pulse amplification system with good beam quality”, LLE Review, Volume 95, pp. 167-178.

Generally, state-of-the-art OPCPA systems use a suitable nonlinear medium such as periodically poled KTiOPO₄ (PPKTP) or BaB₂O₄ (BBO) as core of the optical parametric amplifier into which the pump light is coupled from a Q-switched Nd:YLF or Nd:YAG laser, for instance. For higher peak power of the pump light, this often is derived from a regenerative ps amplifier, the latter then also taking the seed pulse from its own laser source.

In parallel with the pump light, a seed pulse is coupled in which gives rise to the generation of auxiliary beam and signal beam. Here the energy of a single pump beam photon is divided and shared by the two photons of auxiliary and signal beam. The wavelength being generated can be influenced by suitable selection of the beam parameters such as the spectral width, phase, wavelength, and angle of pump pulse and seed pulse.

After generation of the auxiliary and signal beams, the fraction used as laser light is compressed by a pulse compressor.

State-of-the-art laser systems of the OPCPA type thus need a complex structure, characterized more particularly by the two laser sources needed to generate seed pulses and by the units for pulse stretching and pulse compression. Large dimensions or an increased number of folding mirrors are needed more particularly for the pulse compressors, which are built as double-prism lines.

It is a basic task of the invention, therefore, to provide a laser system following the OPCPA principles but having reduced complexity.

A further task is that of improving the characteristics of the pulses generated.

According to the invention, these tasks are met or the solutions developed further by embodiments having the characteristics of claim 1 or those of the dependent claims.

In a laser system according to the invention that follows the OPCPA principles, a single laser source is used to generate the seed pulses for a regenerative amplifier and for the optical parametric amplifier. The use of an auxiliary beam and its recompression in a setup with positive dispersion, and more particularly its second pass through the pulse stretcher, is a further advantageous feature.

For the generation of seed pulses, one can for instance use a diode-pumped femtosecond laser as the source; its pulses are directed along two beam pathways, both into a regenerative amplifier and, for the optimization of overlap on the time scale, via a pulse stretcher and a delay line into the optical parametric amplifier. It will suffice here to have merely partial overlap between the wavelength of the femtosecond laser and the amplification band of the laser medium in the regenerative amplifier. Thus, a pulse having a mean wavelength of about 1060 nm and a spectral width of 12 nm can be used to utilize the amplification band of Nd:YLF at about 1047 nm in a diode-pumped regenerative amplifier. Depending on the pulse repetition rate, typical regenerative amplifiers operated in the picosecond range can attain frequency-doubled energies between 0.1 and 1 mJ. Femtosecond pulses of more than 0.1 mJ and stretching factors of less than 50 are feasible with optical parametric amplifiers having an optimized efficiency of up to 30%.

Picosecond pump pulses have the advantage, moreover, that the nonlinear medium can be kept short, which serves to optimize the nonlinear amplification bandwidth for a given pulse energy.

The pump light generated by the regenerative amplifier can afterwards be frequency-doubled prior to entering the optical parametric amplifier. Seed pulse and pump pulse are coupled into the amplifier in a non-collinear configuration so that the auxiliary beam when utilized is free of any background coming from the seed pulse source. In view of the inverted chirp of the auxiliary beam generated in the amplifier, this beam can be recompressed in a setup with positive dispersion, in which case all orders are, or remain, conjugate. However, according to the invention, a use involving a collinear configuration is possible as well.

Utilizing the pulse stretcher twice, viz., for stretching and, after amplification, for compression of the auxiliary beam pulse is an advantageous possibility here. With this configuration, one of the components can be omitted, and thus the complexity, adjusting effort, and size of the laser system can be reduced.

The possibility of tuning over a certain range arises when white light is used as the seed pulse of the optical parametric amplifier. To this end, a laser pulse of the femtosecond laser source is passed through a suitable component such as a sapphire plate, a photonic fiber, or a tapered fiber. This component may at the same time even be functional as a pulse stretcher, so that a separate pulse stretcher may then not be needed.

In the following, the laser system according to the invention will be described purely by way of examples while referring to embodiments represented schematically in the drawing.

In detail,

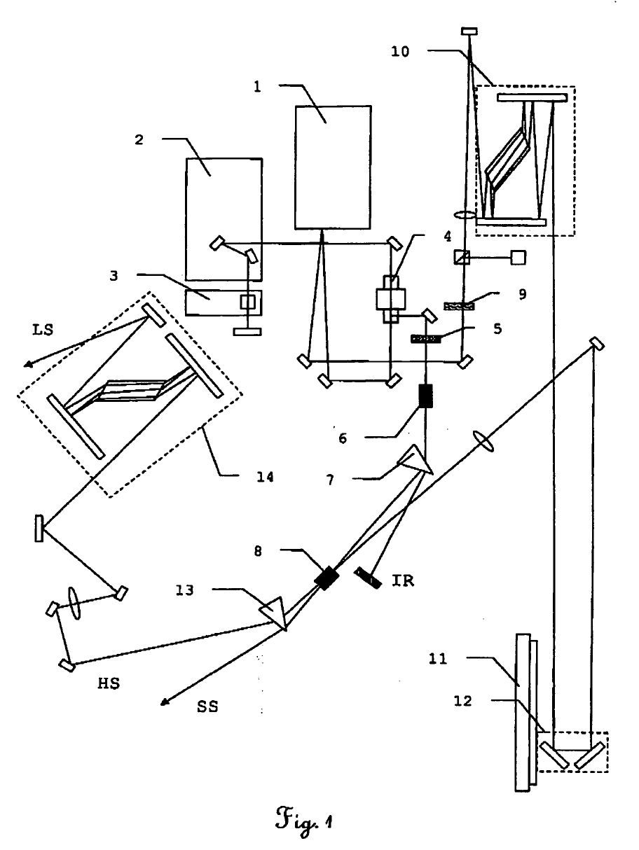

FIG. 1 is the schematic representation of a first exemplified embodiment of the laser system according to the invention;

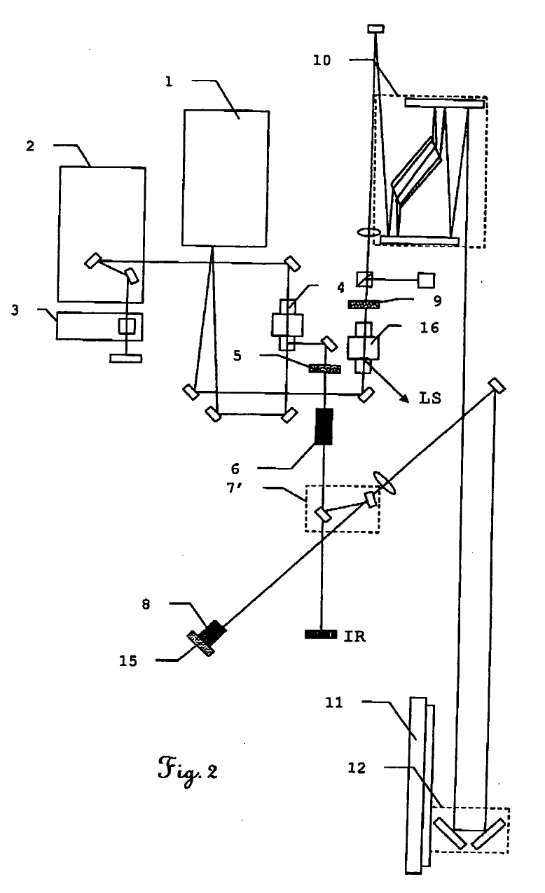

FIG. 2 is the schematic representation of a second exemplified embodiment of the laser system according to the invention;

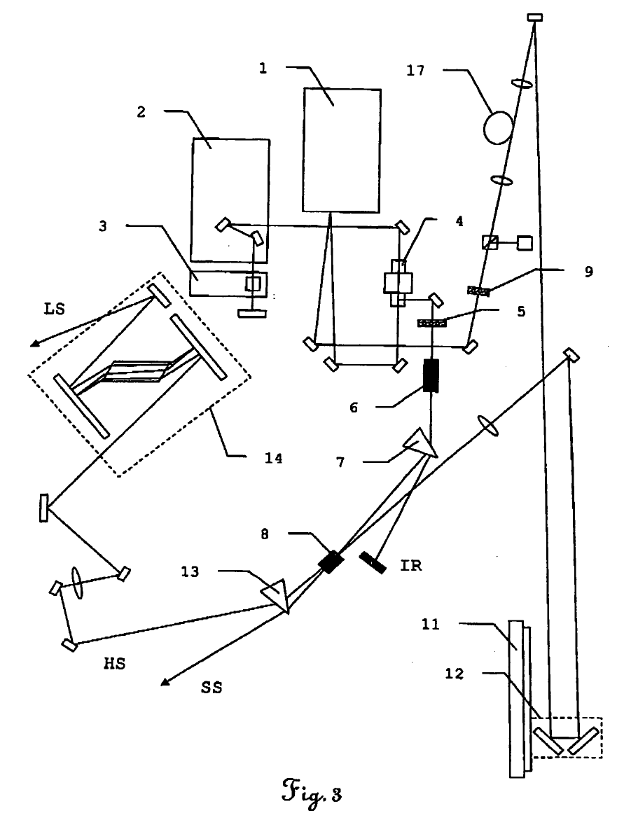

FIG. 3 is the schematic representation of a third exemplified embodiment of the laser system according to the invention;

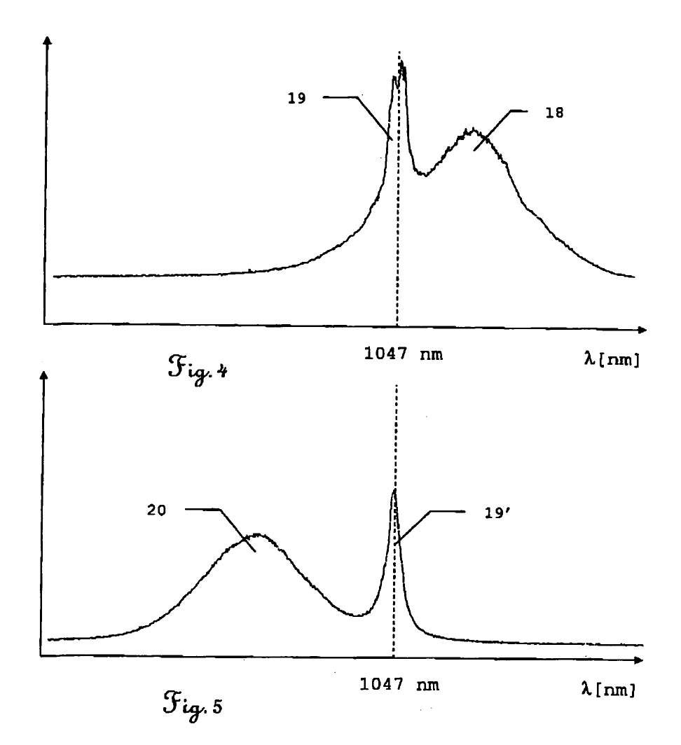

FIG. 4 is the representation of a signal beam spectrum for the first exemplified embodiment;

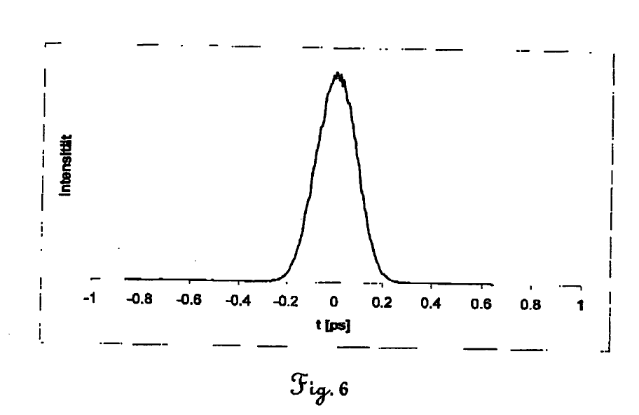

FIG. 5 is the representation of an auxiliary beam spectrum for the first exemplified embodiment; and

FIG. 6 is the representation of the time-dependent autocorrelation of the recompressed auxiliary beam in the first exemplified embodiment.

FIG. 1 schematically represents a first exemplified embodiment of the laser system according to the invention. In the laser system, a laser source 1 generates seed pulses, more particularly seed pulses in the form of femtosecond laser pulses, which for the generation of pump pulses, more particularly pump pulses in the form of picosecond laser pulses, are coupled via a first beam path into a regenerative amplifier 2. As a laser source 1, a seed laser of the FemtoTrain IC-100 Femtosecond Nd:Glass type of High-Q-Laser Inc. having a wavelength of about 1060 nm can for instance be used. This laser generates pulses lasting about 80 fs and having a pulse energy of about 0.5 nJ, with a pulse rate of about 70 MHz while attaining a spectral width of about 12 nm. In the regenerative amplifier 2, Nd:YLF having a narrow amplification band in the region around 1047 nm can be used as the laser medium. The emission of laser source 1 has a spectral overlap with the amplification band of the regenerative amplifier 2, so that a seed effect is achieved. In this example, the regenerative amplifier 2 is operated at 1 kHz. A Pockels cell 3 and a first Faraday insulator 4 are used to couple laser pulses into and out of the regenerative amplifier 2.

After passing a half-wave plate 5, the pump pulses are frequency doubled in a nonlinear element 6, for instance in a BBO crystal, and via a quartz prism 7 serving to separate the green fraction from the IR fraction IR passed on to an optical parametric amplifier 8 for generation of auxiliary beam HS and signal beam SS. In this example, the optical parametric amplifier 8 consists of a PPKTP crystal, which is suitable for generation of the second harmonic of 1047 nm at 523.5 nm or an optical parametric amplification from 523.5 nm to 1047 nm. With a pulse repetition rate of 1 kHz, the pulse energy of the green fraction is about 600 μJ.

From the laser source 1, seed pulses are passed to a pulse stretcher 10 via a second beam path involving a quarter-wave plate 9. In this example, the pulse stretcher 10 which is a component made of a material with positive dispersion includes an element of highly disperse SF57 glass, while for stretching of the pulses the beam is passed a number of times through the material. In the time domain, the pulses are thus stretched from about 80 fs to about 600 fs.

After the pulse stretcher 10, the pulses are directed through a delay line that can be adjusted by a rail 11 and by a retroreflector 12 riding on rail 11. Using this arrangement one can sychronize the times of arrival of pump and seed pulses in the optical parametric amplifier 8. It can be guaranteed in particular that pump and seed pulses meet at the same time. Here the seed pulses enter the optical parametric amplifier 8 at an angle of about 0.5° relative to the pump pulses, so that one obtains an angular multiplexing and a non-collinear amplification. For a PPKTP crystal of the optical parametric amplifier 8 that is 1 mm long, energies of the auxiliary beam HS and the signal beam SS of up to 3 μJ each are measured, corresponding to a parametric gain of about 6000.

After that the signal beam SS is recompressed in a prism line (not shown) that consists of SF10 glass prisms placed at a mutual distance of 1.5 m; here, the signal beam SS and the residual seed pulse have the same beam axis.

The chirp of the seed pulse is mirrored in the auxiliary beam HS, i.e., is spectrally inverted, therefore, a recompression is possible with a structure having positive dispersion. In this first examplified embodiment the auxiliary beam HS is passed via a prism 13 and through a pulse compressor, and then coupled out as a laser beam LS for its utilization. In this variant, the pulse compressor 14 is realized with two mirrors and an element of SF57 glass that has the same design as pulse stretcher 10. As an alternative, any other arrangement having positive dispersion can be used as a pulse compressor 14.

The auxiliary beam can be used as a useful beam, and the different variants of recompression can also be used, independently of the single source that, according to the invention, is used to generate seed pulses. That is, the auxilary beam can be coupled out for further use, also in generic laser systems of the prior art, by using the configuration realized according to the invention.

FIG. 2 is a schematic representation of a second exemplified embodiment of the laser system according to the invention where a pulse compressor is omitted. In this exemplified embodiment, too, seed pulses are generated by a laser source 1 having a structure similar to that of FIG. 1, and coupled into a regenerative amplifier 2 to generate pump pulses. Again, a Pockels cell 3 and a first Faraday insulator 4 are used for the incoupling and outcoupling of laser pulses in the regenerative amplifier 2.

After passing a half-wave plate 5, the pump pulses are frequency-doubled in a nonlinear element 6, and directed to the optical parametric amplifier 8 via a quartz prism 7.

From the laser source 1, seed pulses are directed to a pulse stretcher 10 via a second beam path with quarter-wave plate 9 and a second Faraday insulator 16. In this second exemplified embodiment, the pulse stretcher 10 again has an element of highly dispersive SF57 glass followed by a delay line with rail 11 and retroreflector 12. After passing the delay line, the seed pulses are directed in collinear geometry to the optical parametric amplifier 8 via a dichroitic mirror arrangement 7′, while the amplifier is followed by a reflective element 15 which reflects the signal, auxiliary, and pump beams back so that the pulses of the auxiliary beam are redirected via the delay line to the pulse stretcher 10. In view of the chirp that was time-inverted in the optical parametric amplifier 8, the positive dispersion of pulse stretcher 10 can now be used for recompression. This configuration according to the invention makes it possible to use the same component for pulse stretching and subsequent pulse recompression, so that particularly compact laser systems can be realized.

The potential utilization and compression of the signal beam has not been represented explicitly in this example. This is possible, however, as explained in FIG. 1, when using a prism line and subsequent coupling-out.

FIG. 3 explains a third exemplified embodiment of the laser system according to the invention where white light is used to generate seed pulses. The components and beam path used to generate the pump pulses have not been changed in this third exemplified embodiment, relative to the first two embodiments, hence here again a laser source 1 generates seed pulses which are coupled into a regenerative amplifier 2 to generate pump pulses. After outcoupling and passing a Faraday insulator 4 as well as a half-wave plate 5, these pump pulses are frequency-doubled in a nonlinear element 6, and directed via a quartz prism 7 to the optical parametric amplifier 8.

For generation of a white-light seed pulse, the light from laser source 1 is directed to an element that generates white light, for instance a sapphire plate, a photonic crystal fiber or a tapered fiber. In this third embodiment, purely given as an example, the light of laser source 1 is directed via a quarter-wave plate 9 and appropriate lenses and via a fiber 17, for instance a photonic crystal fiber. In this fiber 17, white light is generated and the pulses are stretched. Other components can also be used for pulse stretching when indicated, for instance in a manner similar to that of FIGS. 1 and 2. The seed pulse passes the delay line with rail 11 and retroreflector 12, and is directed to the optical parametric amplifier 8. In view of the spectral width of the white-light seed pulse, the configuration can be tuned within certain limits, for instance by varying the angle of the beam paths of the pump and seed pulses or by changing the length of the delay line.

After generation, the signal beam SS and the auxiliary beam HS can be directed in a manner analogous to that of FIG. 1. Thus, the signal beam SS can be recompressed by a prism line, and the auxiliary beam HS can be passed through a pulse compressor 14 and then coupled out for utilization as a laser beam LS. Apart from the embodiment of pulse compressor 14 with dispersive element that is shown schematically in FIG. 3, other pulse compressor variants can be realized according to the invention, for instance a combination of grating and lens.

FIG. 4 shows the signal beam spectrum for the first exemplified embodiment. The degeneracy wavelength of 1047 nm of the optical parametric amplifier is marked. The peak seen in the region of this wavelength is due to scattered light 19 of the regenerative amplifier. The peak of the signal beam 18 which has a maximum in the region of about 1060 nm is located toward longer waves.

FIG. 5 shows the auxiliary beam spectrum for the first exemplified embodiment. Relative to the position of the signal beam peak of FIG. 4, the position of the auxiliary beam peak 20 is mirrored relative to the wavelength of 1047 nm so that the maximum is in the region of about 1030 nm. At 1047 nm one can recognize the fraction of scattered light 19′ coming from the regenerative amplifier.

FIG. 6 shows the autocorrelation of the recompressed auxiliary beam as a function of time in a laser system according to the first exemplified embodiment. After stretching of the seed pulses from about 80 fs to a half-power beam width of about 600 fs, the pulses of the auxiliary beam pass through SF57 material to be recompressed to a half-power beam width of about 135 fs using the same path length.

For reasons of simplification, some components such as lenses have not been represented in FIGS. 1 to 3.

The exemplified embodiments represented above do not constitute a definitive listing of possible configurations. More particularly, individual features from different exemplified embodiments can be combined or supplemented by further components and arrangements. The non-collinear arrangement of the optical parametric oscillator or amplifier that was shown can be modified with respect to the parameters in a manner known per se. The concept according to the invention can fundamentally also be used, for instance, for collinear arrangements. Also, several PPKTP crystals can be put in series in an optical parametric oscillator, or one can change for instance the geometry of the individual crystals.

1. Laser system with
a laser source (1) for generating seed pulses, more particularly in the form of femtosecond laser pulses,
a regenerative amplifier (2) for generating pump pulses, more particularly in the form of picosecond laser pulses,
an optical parametric amplifier (8) for generating an auxiliary beam (HS) and a signal beam (SS), the optical parametric amplifier (8) being pumped by the regenerative amplifier (2), characterized in that the seed pulses are coupled into
the regenerative amplifier (2) and
the optical parametric amplifier (8), more particularly via a pulse stretcher (10).

2. Laser system according to claim 1, characterized in that the auxiliary beam (HS) is passed through an arrangement with positive dispersion (10, 14).

3. Laser system according to claim 2, characterized in that the auxiliary beam (HS) is passed through the pulse stretcher (10).

4. Laser system according to claim 1, characterized in that the pulse stretcher (10) has at least one component made of material with positive dispersion, the beam path going a number of times through the material for pulse stretching.

5. Laser system according to claim 1, characterized in that the signal beam (SS) is passed through an arrangement with negative dispersion, more particularly through a double prism line.

6. Laser system according to claim 1, characterized in that the seed pulses are coupled into the optical parametric amplifier (8) in a non-collinear configuration.

7. Laser system according to claim 1, characterized in that the pump pulses are frequency-multiplied, and more particularly frequency-doubled.

8. Laser system according to claim 1, characterized in that the regenerative amplifier (2) includes Nd:YLF as a laser medium.

9. Laser system according to claim 1, characterized in that the laser source (1) is configured to generate white light, more particularly by a subsequent sapphire plate, a photonic fiber, or a tapered fiber.

10. Laser system according to claim 9, characterized in that the pulse stretcher is configured as a fibre (17), more particularly a photonic crystal fiber or tapered fiber.
